(19) United States
(12) Patent Application Publication
(10) Pub. No.: US 2007/0232759 A1
(43) Pub. Date: Oct. 4, 2007

(54) GRAFT COPOLYMER AND METHOD FOR PREPARING THE SAME

(75) Inventors: Moon-seok CHUN, Daejeon (KR); Jin-woo LEE, Daejeon (KR); Choon-hwa LEE, Daejeon (KR); Ik-jun CHOI, Daejeon (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/538,864

(22) Filed: Oct. 5, 2006

(30) Foreign Application Priority Data
Oct. 6, 2005 (KR) 10-2005-0093834

(51) Int. Cl. C08F 259/02; C08F 4/00

(52) U.S. Cl. 525/271; 525/292

(57) ABSTRACT

The present invention relates to a graft copolymer and a method for preparing the same, and more precisely a graft copolymer prepared by the steps of preparing a living activator with a single monomer and a block copolymer of a vinyl aromatic hydrocarbon or a conjugated diene hydrocarbon; and then grafting the prepared living activator to polyolefin polymer, and a method for preparing the same. According to the method of the present invention, the individual vinyl aromatic hydrocarbon or conjugated diene hydrocarbon polymers, and a block copolymer thereof, can be grafted onto chlorinated polyolefin polymer as a branch by using a living activator, and the resultant graft copolymer can be widely applied to various high molecular additives, compatabilizers, waterproof sheets and asphalt, etc.

This application claims the benefit of the filing date of Korean Patent Application No. 10-2005-0093834 filed on Oct. 06, 2005 in the Korean Intellectual Property Office, the disclosure of which is incorporated herein in its entirety by reference.

### TECHNICAL FIELD

The present invention relates to a graft copolymer and a method for preparing the same, and more precisely a graft copolymer prepared by the steps of preparing a living activator with a single monomer and a block copolymer of an aromatic vinyl hydrocarbon or a conjugated diene hydrocarbon; and then grafting the prepared living activator to a polyolefin polymer and a method for preparing the same.

### BACKGROUND ART

A conventional thermoplastic elastomer (referred as ‘TPE’ hereinafter) is a material which was developed in the 1960s having both the elastic property of vulcanized rubber and the processing property of thermoplastic resin, and has been applied to various fields since then.

In particular, styrene TPE has a phase-separated structure between a polystyrene block (hard phase) and an elastomer block (elastomer phase) at room temperature and can be modified into a double block- or multi-block structure.

The most representative styrene TPE is styrene-butadiene-styrene block copolymer, prepared by Shell Chemical in 1965 (SBS block copolymer, Kraton®). Thereafter, styrene-isoprene-styrene block copolymer (polystyrene-block-polyisoprene-block-polystyrene, referred to as ‘SIS’ hereinafter), styrene-(ethylene-butylene)-styrene block copolymer (polystyrene-(polyethylene-block-polybutylene)-polystyrene, referred to as ‘SEBS’ hereinafter) having a hydrogenated polydiene midblock, and styrene-(ethylene-propylene)-styrene block copolymer (polystyrene-(polyethylene-block-polypropylene)-polystyrene, referred to as ‘SEPS’ hereinafter) have been developed.

Styrene TPE can be molded into various forms because the polystyrene block therein exhibits the thermoplastic resin like fluidity at a high temperature over the glass transition temperature. In addition, the styrene TPE has an excellent cryogenic property under −60° C., the brittleness temperature, so as to be applied to a low hardness area. The styrene TPE has also an advantage of less chance of hardness change according to temperature, compared with soft PVC or EVA (ethylene-vinyl acetate copolymer).

Especially, if the styrene TPE contains a hydrogenated elastomer block such as ethylene-butylene or ethylene-propylene, exemplified by SEBS or SEPS, its compatibility with polyolefin or polypropylene will be increased, compared with SBS or SIS, making it an excellent candidate for improving the properties of polyolefin resin. SEBS and SEPS have the disadvantage of a high melt viscosity, but can maintain excellent mechanical properties at high temperature, suggesting that they have a wide temperature range for application. Unlike SBS or SIS, SEBS and SEPS have no double bonds in their structure, indicating that gelation during high temperature processing can be inhibited and thereby weatherability will be increased.

U.S. Pat. No. 3,415,759 and No. 5,057,582 describe methods for preparing SEBS and SEPS. Particularly, according to the descriptions, SEBS and SEPS can be polymerized by hydrogenation with an ethylene unsaturated hydrocarbon, an aromatic unsaturated hydrocarbon or an ethylene unsaturated/aromatic unsaturated hydrocarbon. The selective hydrogenation of an unsaturated hydrocarbon can be performed by using a catalyst prepared by mixing nickel (VIII metal) or cobalt and aluminum alkyl (a reducing agent).

However, to prepare a thermoplastic elastomer by hydrogenation, highly expensive metallic hydrogen catalyst has to be added, resulting in the increase of production costs. In addition, the hydrogenation process and the additional post-treatment processes make the production very complicated and require a long production time.

During hydrogenation using a metallic catalyst, the activation and the selectivity of the hydrogenation are inversely related, suggesting that the optimal point has to be determined for high hydrogenation efficiency. For example, if a specific metallic catalyst added for the hydrogenation has high selectivity for an unsaturated organic compound, the poisoning of the catalyst will be observed by a reduction in the activity of the catalyst, resulting in a decrease of hydrogenation efficiency. In particular, if an unsaturated polymer contains a poisoning-sensitive functional group or coupling agent, the reactivity will be decreased or even hydrogenation itself will not be allowed.

Therefore, it is necessary to develop a novel thermoplastic elastomer having excellent high temperature stability and a wide temperature range, like hydrogenated styrene TPE, and at the same time requiring low production costs and a simple and easy production process, and to develop a method of the same.

### DISCLOSURE OF THE INVENTION

It is an object of the present invention, in order to solve the above problems, to provide a thermoplastic elastomer graft copolymer a containing chlorinated polyolefin chain having branches composed of a copolymer of a vinyl aromatic hydrocarbon or a conjugated diene hydrocarbon, or a block copolymer thereof, and a method for preparing the same.

It is another object of the present invention to provide a graft copolymer for regulating the graft rate by controlling the activity of the independent copolymer of the vinyl aromatic hydrocarbon or conjugated diene hydrocarbon, or a block copolymer thereof, and a method for preparing the same.

The above objects and other objects of the present invention can be achieved by the following embodiments of the present invention.

To achieve the above objects, the present invention provides a graft copolymer represented by the following formula 1: [symbol]
A [symbol] graft [symbol] B₁-block-B₂ [symbol] [Formula 1]

(Wherein, A is chlorinated polyolefin with a degree of chlorination of 1˜99%, B₁ and B₂ are independently polymers composed of a vinyl aromatic hydrocarbon or a conjugated diene hydrocarbon, respectively.)

The present invention also provides a method for preparing the graft copolymer of formula 1 which comprises the following steps:

a) preparing a living activator of a single or a block copolymer selected from a vinyl aromatic hydrocarbon and a conjugated diene hydrocarbon in the presence of a hydrocarbon solvent and an organic lithium compound, and

b) preparing the graft copolymer by reacting the living activator with chlorinated polyolefin.

Hereinafter, the present invention is described in detail.

The method of the present invention is characterized by grafting one of a vinyl aromatic hydrocarbon copolymer or a conjugated diene hydrocarbon copolymer alone, or a block copolymer thereof (as a branch), to the chlorinated polyolefin chain by using the living activator, and thereby easily grafting the copolymer block to the chlorinated polyolefin without the conventional hydrogenation.

The graft copolymer of the present invention is represented by the following formula 1: [symbol]
A [symbol] graft [symbol] B₁-block-B₂ [symbol] [Formula 1]

(Wherein, A is chlorinated polyolefin with a degree of chlorination of 1˜99%, B₁ and B₂ are independently polymers composed of a vinyl aromatic hydrocarbon or a conjugated diene hydrocarbon, respectively.)

Chlorinated polyolefin indicated as A preferably has a number average molecular weight of 1,000˜1,000,000, and B₁-block-B₂ block copolymer preferably has a number average molecular weight of 1,000˜1,000,000. If B₁ is a different polymer from B₂, the weight ratio of B₁ to B₂ is preferably 99:1˜1:99.

The vinyl aromatic monomer can be one or more compounds selected from a group consisting of styrene, α-methylstyrene, 3-methylstyrene, 4-methylstyrene, 4-propylstyrene, 1-vinylnaphthalene, 4-cyclohexylstyrene, 4-(p-methylphenyl)styrene and 1-vinyl-5-hexylnaphthalene, and among these, styrene or methylstyrene is more preferred.

The conjugated diene monomer can be one or more compounds selected from a group consisting of 1,3-butadiene, 2,3-dimethyl-1,3-butadiene, piperylene, 3-butyl-1,3-octadiene, isoprene and 2-phenyl-1,3-butadiene, and particularly 1,3-butadiene or isoprene is more preferred.

It is also preferred that the graft copolymer of formula 1 has the structure in which B₁-block-B₂ is grafted as a branch to chlorinated polyolefin at the content of 0.1˜99%, and more preferably 0.5˜80%, which exhibits improved workability owing to the polyolefin and improved elasticity owing to the B₁-block-B₂ block copolymer, indicating that the graft copolymer is a suitable thermoplastic elastomer.

The method for preparing the graft copolymer of chemical formula 1 comprises the following steps:

a) preparing a living activator for a single or a block copolymer, selected from a vinyl aromatic hydrocarbon and a conjugated diene hydrocarbon in the presence of a hydrocarbon solvent and an organic lithium compound, and

b) preparing the graft copolymer by reacting the living activator with chlorinated polyolefin.

According to the present invention, a polymer for grafting can be prepared in the form of a living activator and the living activator can be easily grafted to chlorinated polyolefin without additional hydrogenation.

The method of preparing the present invention is described step by step hereinafter.

In step a), to a reactor were added a hydrocarbon solvent and an organic lithium compound, in which a vinyl aromatic hydrocarbon or a conjugated diene hydrocarbon monomer is polymerized to form a B₁-block-B₂ block copolymer, resulting in the living activator.

If B₁ and B₂ are the same monomer, polymerization has to be induced until at least 99% of the monomer is consumed to give the living activator.

In the meantime, if B₁ and B₂ are two different monomers, polymerization has to be induced at first until at least 99% of the B₁ monomer is consumed and then the B₂ monomer is added thereto to form the living activator comprising the B₁-block-B₂ block copolymer.

The B₁ monomer can be one of the vinyl aromatic hydrocarbon monomer and the conjugated diene hydrocarbon monomer, and the vinyl aromatic hydrocarbon is preferably selected first as the B₁ monomer and then the conjugated diene hydrocarbon is preferably selected as the B₂ monomer. The vinyl aromatic hydrocarbon or conjugated diene hydrocarbon contains a double bond in its molecule, indicating that the compound might be an electron acceptor. Thus, the resultant living activator will be more stable if the terminal of the compound is anionized.

The ratio of the B₁ block and the B₂ block is adjusted in the possible range of 0˜100%. The length of the B₁-block-B₂ block copolymer to be grafted to chlorinated polyolefin is properly adjusted and one or more monomers can be serially added to the B₁ and B₂ monomers to give living activators of various structures.

The organic lithium compound is acting as a polymerization initiator to start the polymerization reaction of the vinyl aromatic hydrocarbon monomer or the conjugated diene hydrocarbon monomer, and is involved in the formation of anions at the terminal to form a living activator.

Alkyl lithium compound can be used as the organic lithium compound, and particularly alkyl lithium compound harboring a C3˜C10 alkyl group is preferred. The preferable content of the organic lithium compound to the vinyl aromatic monomer or conjugated diene monomer is 0.005˜15 weight part.

The organic lithium compound can be selected from a group consisting of methyl lithium, ethyl lithium, isopropyl lithium, n-butyl lithium, sec-butyl lithium, tert-butyl lithium, n-decyl lithium, tert-octyl lithium, phenyl lithium, 1-naphthyl lithium, n-eicosyl lithium, 4-butylphenyl lithium, 4-tolyl lithium, cyclohexyl lithium, 3,5-di-n-heptylcyclohexyl lithium and 4-cyclopentyl lithium, and among these, n-butyl lithium or sec-butyl lithium is more preferred.

The acceptable hydrocarbon solvent in this step is exemplified by n-pentane, n-hexane, n-heptane, isooctane, cyclohexane, toluene, benzene or xylene. In addition, a single or a mixed solvent selected from a group consisting of various aromatic hydrocarbons and naphthalene hydrocarbons can be used. It is preferred to select n-hexane, cyclohexane or a mixture of the two as the hydrocarbon solvent over the above compounds.

To the hydrocarbon solvent is added a small amount of a polar solvent to regulate the vinyl content during the polymerization of the vinyl aromatic monomer or conjugated diene monomer, and to increase polymerization speed. The acceptable polar solvent can be one or more compounds selected from a group consisting of tetrahydrofuran, ethyl ether and tetramethylethylenediamine, and particularly tetrahydrofuran is preferred. The content of the polar solvent in the hydrocarbon solvent is preferably not more than 30 weight part.

The reaction depends on the polymerization method and temperature, and it is preferred to induce the reaction at −50˜150° C. with enough pressure that is able to maintain the reactant in the liquid phase until the monomer is completely consumed.

In step b), the prepared living activator and chlorinated polyolefin are reacted to give the graft copolymer.

The chlorinated polyolefin has a degree of chlorination of 1˜99% and a number average molecular weight of 1,000˜1,000,000, which can be produced or purchased.

The graft copolymerization is performed in the presence of a hydrocarbon solvent, in which the living activator and chlorinated polyolefin are added at the content of 1˜99 weight % and the temperature is −15° C.˜150° C.

To accelerate the reaction, a small amount of a reaction accelerator can be added and the content is preferably 0.5˜30 molar ratio of the living activator. The reaction accelerator activates the alkyl lithium at the terminal of the vinyl aromatic hydrocarbon/conjugated diene hydrocarbon block polymer to promote a substitution reaction.

The reaction accelerator can be one or more compounds selected from a group consisting of tert-aliphatic amine, tert-diamine, triamine, dipyrrolidoneethane and tetramethyl-ethylene-diamine (TMEDA), and is preferably tetramethyl-ethylene-diamine (TMEDA).

To terminate the reaction, a reaction terminator selected from a group consisting of alcohol and water can be used.

The method of preparing the present invention facilitates the graft-copolymerization of the lithium living activator and chlorinated polyolefin without the conventional hydrogenation. According to the method of the present invention, a polar solvent and a reaction accelerator are added to regulate the activity of the vinyl aromatic hydrocarbon copolymer or the conjugated diene copolymer forming the B₁-block-B₂ block copolymer, to regulate the amount of grafting.

The prepared graft-copolymer of the present invention preferably has a number average molecular weight of 5,000˜5,000,000 to maintain its mechanical properties and physical properties and exhibits a graft rate 0.5˜80%, but is not always limited thereto.

The workability of the graft copolymer can be increased by chlorinated polyolefin, and the elasticity thereof can be improved by the B₁-block-B₂ block copolymer so that the resultant copolymer is suitable as a thermoplastic elastomer and can be molded by a conventional thermoplastic resin molding method selected from a group consisting of injection molding, extrusion molding, transfer molding, inflation molding, blow molding, thermo-molding, compression molding and vacuum molding.

In addition, the range of applications of the copolymer is very wide, including various molded products, fibers, films, sheets, plastic modifiers, paints, adhesives, high molecular additives, compatabilizers, waterproof sheets and asphalt, etc.

### BEST MODE FOR CARRYING OUT THE INVENTION

Practical and presently preferred embodiments of the present invention are illustrated as shown in the following examples.

However, it will be appreciated that those skilled in the art, on consideration of this disclosure, may make modifications and improvements within the spirit and scope of the present invention.

### EXAMPLE

### Example 1

### Preparation of Chlorinated Polyolefin/Polystyrene Graft Copolymer (CPO-g-PS)

(1) Preparation of Polystyrene Living Activator

To a 10 L reactor with nitrogen substitution were added 380 g of purified cyclohexane and 35 g of styrene, to which 9.7 g of n-butyl lithium was added until the temperature of the mixture reached 65° C., leading to the polymerization of polystyrene. The polymerization was not terminated until the styrene was completely consumed.

The molecular weight of the prepared linear polystyrene lithium living polymer was 1,000 g/mol and the styrene block content was 100 weight %.

(2) Preparation of Graft Copolymer

To a 500 mL reactor with nitrogen substitution were added 245 g of cyclohexane and 2 g of chlorinated polyolefin having a chlorine content of 36 weight %, followed by the reflux of cyclohexane to eliminate remaining moisture.

To the mixture was added 30 g of the polystyrene lithium living polymer, followed by graft-polymerization at 70° C. for 12 hours. Then, 0.5 g of water was added to the reactor and the reaction was terminated after 5 minutes.

The resultant graft copolymer was progressed to a soxhlet apparatus to eliminate the remaining nonreacted lithium living polymer.

### Example 2

### Preparation of Chlorinated Polyolefin/Polystyrene Graft Copolymer (CPO-g-PS)

An experiment was performed in the same manner as described in Example 1 except that the graft copolymerization of polyolefin/polystyrene in step (2) was carried out by using 12 g of tetrahydrofuran, a polar solvent, and 233 g of cyclohexane.

### Example 3

### Preparation of Chlorinated Polyolefin/Polystyrene Graft Copolymer (CPO-g-PS)

An experiment was performed in the same manner as described in Example 1 except that the graft copolymerization of chlorinated polyolefin/polystyrene block in step (2) was induced with the addition of 3.5 g of tetramethyl-ethylene-diamine (TMEDA), a reaction accelerator, to increase reactivity.

### Example 4

### Preparation of Chlorinated Polyolefin/Polybutadiene Graft Copolymer (CPO-g-PB)

(1) Preparation of Polybutadiene Living Activator.

To a 10 L reactor with nitrogen substitution were added 380 g of purified cyclohexane and 25 g of butadiene, to which 9.7 g of n-butyl lithium was added until the temperature of the mixture reached 65° C., leading to the polymerization of polybutadiene. The polymerization was not terminated until the butadiene was completely consumed.

The molecular weight of the prepared linear polybutadiene lithium living polymer was 1,000 g/mol and the butadiene block content was 100 weight %.

(2) Preparation of Graft Copolymer

To a 500 mL reactor with nitrogen substitution were added 245 g of cyclohexane and 2 g of chlorinated polyolefin having a chlorine content of 36 weight %, followed by the reflux of cyclohexane to eliminate remaining moisture.

To the mixture was added 25 g of the polybutadiene lithium living polymer, followed by graft-polymerization at 70° C. for 12 hours. Then, 0.5 g of water was added to the reactor and the reaction was terminated after 5 minutes.

The resultant graft copolymer was progressed to a soxhlet apparatus to eliminate the remaining nonreacted lithium living polymer.

### Example 5

### Preparation of Chlorinated Polyolefin/Polystyrene-Polybutadiene Graft Copolymer (CPO-g-PS-b-PB)

(1) Preparation of Polystyrene-Polybutadiene Living Activator

To a 10 L reactor with nitrogen substitution were added 380 g of purified cyclohexane and 35 g of styrene, to which 9.7 g of n-butyl lithium was added until the temperature of the mixture reached 65° C., leading to the polymerization of styrene. The polymerization was not terminated until the styrene was completely consumed.

5 g of butadiene was added to the reactor, and the reaction was not terminated until the butadiene was completely consumed. The activity of the prepared lithium living polymer depends on the terminal of butadiene. The molecular weight of the prepared linear block copolymer was 1,000 g/mol and the styrene block content was 95 weight %.

(2) Preparation of Graft Copolymer

To a 500 mL reactor with nitrogen substitution were added 245 g of cyclohexane and 2 g of chlorinated polyolefin having a chlorine content of 36 weight %, followed by the reflux of cyclohexane to eliminate remaining moisture.

To the mixture was added 30 g of the polystyrene/polybutadiene lithium living block copolymer, followed by graft-polymerization at 70° C. for 12 hours. Then, 0.5 g of water was added to the reactor and the reaction was terminated after 5 minutes.

The resultant graft copolymer was progressed to a soxhlet apparatus to eliminate the remaining nonreacted lithium living polymer.

The elastomer block contents of the graft copolymers prepared in Examples 1˜5 were measured by ¹³C-NMR and the graft numbers per 1OK of chain molecular weight were measured by the following mathematical formula 1. The results are shown in Table 1.
Ng={10,000×Wg}/{Mg×(1−Wg)} [Mathematical Formula 1]

(Wherein, Ng indicates the number of grafted molecules per 10,000 g of chain molecular weight, Wg indicates the weight ratio of polystyrene or polybutadiene block in the graft polymer, Mg indicates the number average molecular weight of polystyrene or polybutadiene block in the graft polymer.)

TABLE 1

| | Example 1 | Example 2 | Example 3 | Example 4 | Example 5 |
|---|---|---|---|---|---|
| Graft | CPO-g-PS | CPO-g-PS | CPO-g-PS | CPO-g-PB | CPO-g- |
| copolymer | | | | | (PS-b-PB) |
| structure | | | | | |
| Graft | 0.9 | 2.4 | 3.5 | 1.4 | 1.3 |
| number/ | | | | | |
| 10K of | | | | | |
| chain | | | | | |
| molecular | | | | | |
| weight | | | | | |
| Grafted PS | 11.5 | 20.0 | 25.0 | 15.0 | 14.9 |
| and PB or | | | | | |
| block | | | | | |
| content (%) | | | | | |

As shown in Table 1, NMR results confirmed that styrene or butadiene was introduced in the chlorinated polyolefin chain after graft polymerization, and the graft rate was increased with the addition of a polar solvent and a reaction accelerator. The increased graft rate of polybutadiene lithium living polymer and polybutadiene/polystyrene copolymer lithium living polymer indicates that the reactivity of the polybutadiene lithium living activator is higher than that of the polystyrene lithium living activator.

Compared with the graft rate of the copolymer of Example 1, the graft rates of the graft copolymers prepared in Examples 2˜3 increased after the addition of tetrahydrofuran, a polar solvent, and tetramethyl-ethylene-diamine (TMEDA), a reaction accelerator. This suggests that the two added compounds could accelerate the reaction to increase graft efficiency.

### INDUSTRIAL APPLICABILITY

As explained hereinbefore, according to the present invention, a polystyrene copolymer and a polybutadiene copolymer can be directly introduced into a chlorinated polyolefin chain singly or together as a block copolymer without additional hydrogenation, and the reaction speed and graft rate can be regulated by using a polar solvent and a reaction accelerator.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

1. A graft copolymer represented by the following formula 1: [symbol]
A [symbol] graft [symbol] B₁-block-B₂ [symbol] [Formula 1]
Wherein, A is chlorinated polyolefin with a degree of chlorination of 1˜99%, and each of B₁ and B₂ are independently polymers composed of a vinyl aromatic hydrocarbon or a conjugated diene hydrocarbon.

2. The graft copolymer according to claim 1, wherein the number average molecular weight of the chlorinated polyolefin is 1,000˜1,000,000.

3. The graft copolymer according to claim 1, wherein the number average molecular weight of the B₁-block-B₂ block copolymer is 1,000˜1,000,000.

4. The graft copolymer according to claim 1, wherein the graft rate of the B₁-block-B₂ block copolymer is 0.1˜99%.

5. The graft copolymer according to claim 1, wherein if B₁ and B₂ in the B₁-block-B₂ block copolymer are different polymers, the weight ratio of B₁ and B₂ is in the range of 0˜100 weight %.

6. The graft copolymer according to claim 1, wherein the vinyl aromatic hydrocarbon is one or more compounds selected from a group consisting of styrene, α-methylstyrene, 3-methylstyrene, 4-methylstyrene, 4-propylstyrene, 1-vinylnaphthalene, 4-cyclohexylstyrene, 4-(p-methylphenyl)styrene, and 1-vinyl-5-hexylnaphthalene.

7. The graft copolymer according to claim 1, wherein the conjugated diene monomer is one or more compounds selected from a group consisting of 1,3-butadiene, 2,3-dimethyl-1,3-butadiene, piperylene, 3-butyl-1,3-octadiene, isoprene and 2-phenyl-1,3-butadiene.

8. A method for preparing the graft copolymer of claim 1, which comprises the following steps:
a) preparing a living activator for a single or a block copolymer selected from a vinyl aromatic hydrocarbon and a conjugated diene hydrocarbon in the presence of a hydrocarbon solvent and an organic lithium compound, and
b) preparing the graft copolymer by reacting the living activator with chlorinated polyolefin.

9. The method for preparing the graft copolymer according to claim 8, wherein the hydrocarbon solvent is one or more compounds selected from a group consisting of n-pentane, n-hexane, n-heptane, isooctane, cyclohexane, toluene, benzene and xylene.

10. The method for preparing the graft copolymer according to claim 8, wherein the organic lithium compound is one or more compounds selected from a group consisting of methyl lithium, ethyl lithium, isopropyl lithium, n-butyl lithium, sec-butyl lithium, tert-butyl lithium, n-decyl lithium, tert-octyl lithium, phenyl lithium, 1-naphthyl lithium, n-eicosyl lithium, 4-butylphenyl lithium, 4-tolyl lithium, cyclohexyl lithium, 3,5-di-n-heptylcyclohexyl lithium and 4-cyclopentyl lithium.

11. The method for preparing the graft copolymer according to claim 8, wherein the reaction to prepare a living activator is not terminated until at least 99% of the monomer is consumed.

12. The method for preparing the graft copolymer according to claim 8, wherein a polar solvent is additionally added in step b).

13. The method for preparing the graft copolymer according to claim 12, wherein the polar solvent is one or more compounds selected from a group consisting of tetrahydrofuran, ethyl ether and tetramethylethylenediamine.

14. The method for preparing the graft copolymer according to claim 12, wherein the polar solvent is used less than 30 weight part for the weight of the hydrocarbon solvent.

15. The method for preparing the graft copolymer according to claim 8, wherein a reaction accelerator is additionally added in step b).

16. The method for preparing the graft copolymer according to claim 15, wherein the reaction accelerator is one or more compounds selected from a group consisting of tert-aliphatic amine, tert-diamine, triamine, dipyrrolidoneethane and tetramethyl-ethylene-diamine (TMEDA).

17. The method for preparing the graft copolymer according to claim 15, wherein the content of the reaction accelerator is 0.5˜30 molar rate for the living activator.
